(19) United States
(12) Patent Application Publication
(10) Pub. No.: US 2012/0103204 A1
(43) Pub. Date: May 3, 2012

(54) Nutcracker Meat Extractor

(76) Inventor: Antolin Du Bois, New York, NY (US)

(21) Appl. No.: 12/916,490

(22) Filed: Oct. 30, 2010

(51) Int. Cl. A23N 5/00

(52) U.S. Cl. 99/568

(57) ABSTRACT

A nutcracker that focuses on the extraction of the nut-meat after the nut has been cracked by having the lever arms end resembling serrated flathead screwdrivers which allow for the easy plucking out of the meat after the shell has been cracked.

### BACKGROUND OF THE INVENTION

Nutcrackers are certainly a crowded art field in the present and past history of patent literature, in fact hundreds of patents have been issued within the last twenty years alone. With regards to hand-held nutcrackers, dozens have been issued in same two decades. And while the field of handheld nutcrackers has experienced an explosion of creativity and innovation, most if not all of the handheld nutcrackers have focused on the cracking of the nut, not the extraction of the nutmeat; the nutmeat is assumed to easily ‘fall out’ once the nut is cracked. This invention relates to the extraction of nut-meat from a cracked nut, especially when the nut is cracked to badly to place again in the nutcracker, but the meat is still very hard to extract with one's fingers.

Primarily, there are three types of handheld nutcrackers with lever arms disclosed. There are handheld nutcrackers having two lever arms with two pivot points, as disclosed in U.S. Pat. Nos. 4,173,825, U.S. Pat. No. 4,614,034, and U.S. Pat. No. D311,306. There are handheld nutcrackers having two lever arms but with one pivot point, as disclosed in U.S. Pat. No. D509,412, U.S. Pat. No. 6,151,782, and U.S. Pat. No. 4,554,737. And lastly there are handheld nutcrackers having two lever arms but no pivot point but accomplish the cracking of the nut by squeezing, as disclosed in U.S. Pat. No. 6,052,906, and U.S. Pat. No. 6,041,504.

It can readily assumed with the whether or not the handheld nutcracker with two lever arms has two, one, or no pivot point(s), the nut under consideration will certainly get cracked. Oftentimes however, the nutmeat will get ‘stuck’ inside the crushed nut, and is difficult to get out. One must then try to re-crack the nut without cracking the meat, or try to extract the nutmeat by hand. Another alternative is to obtain some other kitchen utensil, and risk damaging the nutmeat with a fork or spoon, or risk danger to one's person with a knife. A pair of pliers would be the best tool, but oftentimes a pair is not located in the kitchen, and perhaps was previously used for some disgusting and dirty job.

### DESCRIPTION OF THE INVENTION

The above problem of nutmeat extraction is alleviated by focusing on the lever ends of the nutcracker. If, instead of having lever arms that end uselessly some distance away from the nut, each ended in flathead like screwdriver with an inside serrated edge, the nutcracker would still be artistically appealing and retain its designed image, but essentially function dually as a nut-cracking tool and a nut-extraction tool. Much time and effort will be saved, and possibly accidents averted, while shelling nuts, for by simply turning the nutcracker around and using the tapered serrated edges after cracking the nut, the nutmeat can be safely and securely gripped and removed. These tapered serrated lever ends can be applied to all types of handheld nutcrackers with two lever arms, be they two pivot point lever arm types, one pivot point lever arm types, or squeeze action types.

Furthermore, since the future of handheld nutcrackers might be in the direction of having three or more lever arms the addition of tapered serrated endings to handheld nutcrackers invention with more than two lever arms is contemplated and considered.

### DESCRIPTION OF THE DRAWINGS

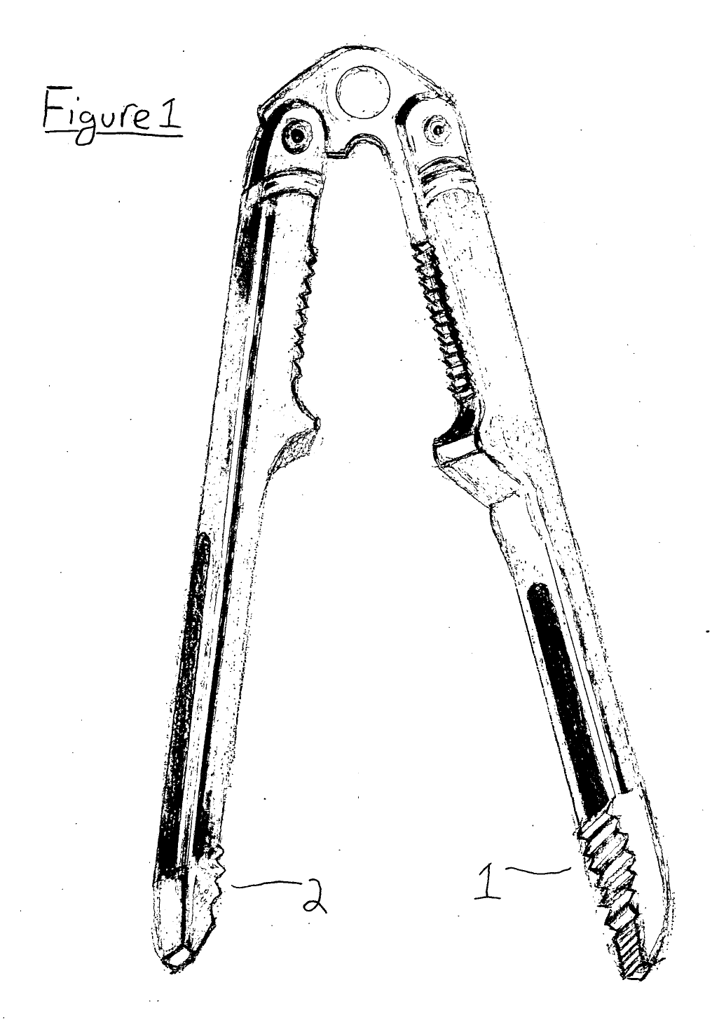

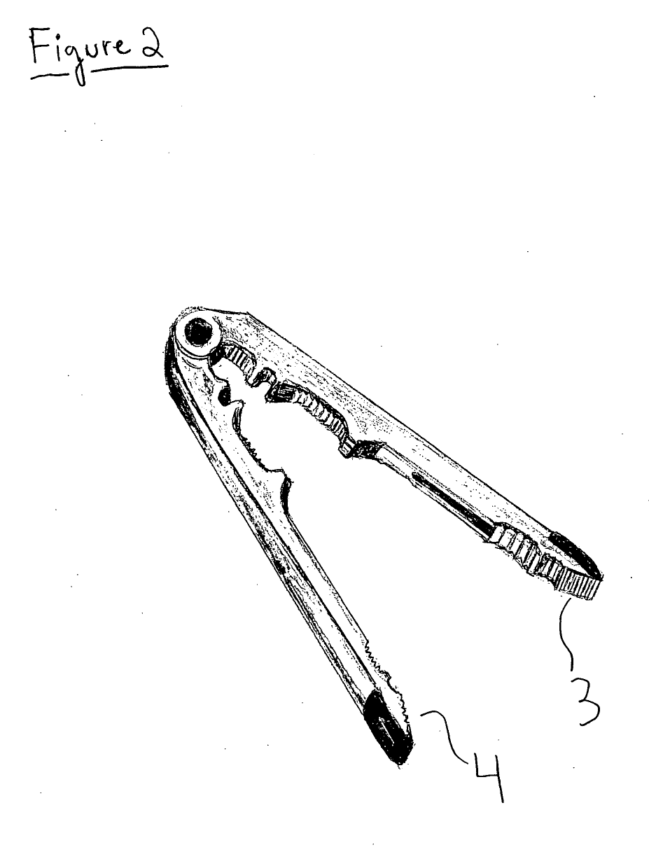

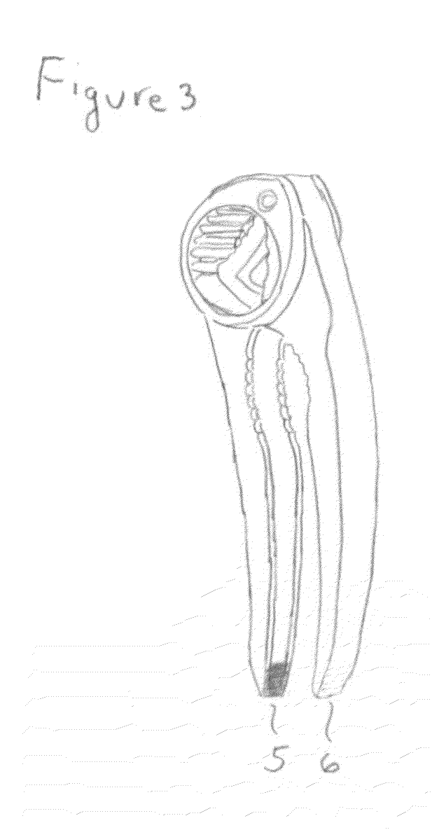

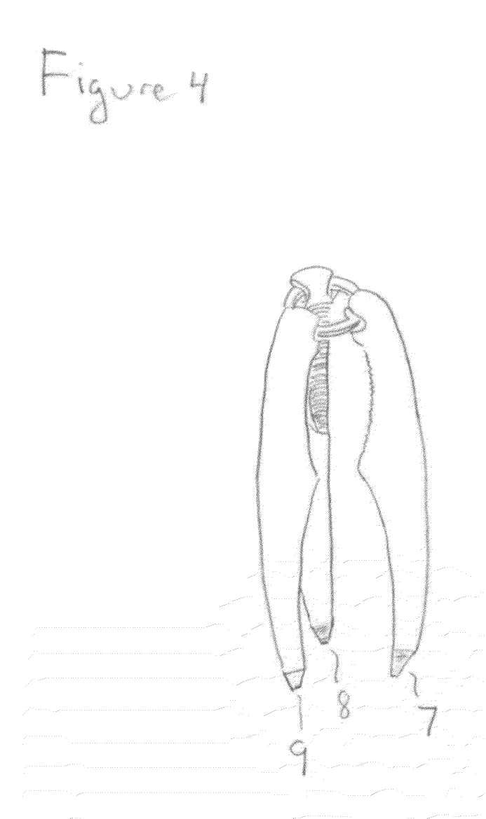

Figure one (1) displays the common nutcracker with two pivot points, the tapered serrated edges are located at 1 and 2. Figure two (2) displays a single pivot point nutcracker, the tapered serrated edges are located at 3 and 4. Figure three (3) displays a ‘squeeze’ type nutcracker, the tapered serrated edges are located at 5 and 6. FIG. 4 displays a nutcracker with more than two levers, the tapered serrated edges are located at 7, 8, and 9.

The invention claimed is:

1) Two or more elongate rigid members that terminate in flat, tapered, and serrated ends, located on the non-compression ends of compression producing cracking devices.
